(19) United States
(12) Patent Application Publication
(10) Pub. No.: US 2008/0184786 A1
(43) Pub. Date: Aug. 7, 2008

(54) WHEEL SENSOR WITH VALVE

(75) Inventors: John Michael Bailey, Hingham (GB); Andrew Paul Rice, Montsegur (FR); James Edward Phillips, Norwich (GB); Gavin Mark Skipper, Sutton (GB); James Ravi Shingleton, Bracon Ash (GB)

Correspondence Address: WORKMAN NYDEGGER, 60 EAST SOUTH TEMPLE, 1000 EAGLE GATE TOWER, SALT LAKE CITY, UT, 84111, US

(73) Assignee: Beru F1 Systems Limited, Diss (GB)

(21) Appl. No.: 11/775,629

(22) Filed: Jul. 10, 2007

(30) Foreign Application Priority Data
Jan. 31, 2007 (GB) 0701819.5

(51) Int. Cl. B60C 23/04

(52) U.S. Cl. 73/146.8

(57) ABSTRACT

A wheel sensor which is primarily located outside of a pneumatic tire includes a sensor for sensing one or more conditions within the pneumatic tire of a wheel and a connector configured to secure the sensor to the wheel rim; wherein the connector establishes a link between the medium inside the tire and the sensor; and includes a valve which seals when the sensor is removed from the rim and opens when the sensor is attached to the rim.

### CROSS-REFERENCE TO RELATED APPLICATIONS

This application claims priority to United Kingdom Application No. GB 0701819.5, filed Jan. 31, 2007, which for purposes of disclosure is incorporated herein by specific reference.

### BACKGROUND OF THE INVENTION

1. The Field of the Invention

The invention relates to wheel sensors and in particular sensors which sense one or more conditions within a pneumatic tire of a wheel.

2. The Relevant Technology

The following patent applications were identified: U.S. Pat. No. 4,768,574; EP 0 206 002; U.S. Pat. No. 4,953,394; EP 0 361 005; EP 0 376 053; ES 2 061 288T; DE 196 24 800; EP 0 987 475; DE 100 47 853; US 2002/134428; DE 20 2004 020 121U1; WO 94/13991; U.S. Pat. No. 5,173,856; U.S. Pat. No. 4,235,184; U.S. Pat. No. 4,117,281; U.S. Pat. No. 6,218,937; WO 2004/016455; EP 1 547 826; US 2005/0134446; WO 00/74958; US 2005/0023896 and U.S. Pat. No. 5,033,295.

None of the valves/sensors disclosed in the above patent documents would be suitable for sensing the tire pressure of the outer tire in a NASCAR two tire setup. This is because the space between the outer most ply of the outer tire at the rim level and the outer most ply of the inner tire is minute. Any protrusion of a bolt or any other securing device would render very difficult if not impossible to achieve the attachment of the inner tire to the rim prior to attaching the outer tire. For this reason, the pressure in the inner tire is usually sensed without any data being provided or measured for the outer tire. This can have the consequence of critical tire conditions going unchecked which can have dangerous consequences particularly in a race car.

### SUMMARY OF THE INVENTION

In its broadest independent aspect, the invention provides a wheel sensor which is primarily located outside of a pneumatic tire comprising sensing means for sensing one or more conditions within the pneumatic tire of a wheel and an attachment means configured to secure said sensing means to the wheel rim; wherein said attachment means establishes a link between the medium inside the tire and said sensing means; and comprises a valve which seals when the sensing means is removed and opens when the sensing means is attached to the rim.

This configuration is particularly advantageous because it allows the conditions within the outer tire of a NASCAR to be measured and the sensor to be removed without causing deflation of the tire. It also allows the electronics element to be changed if necessary without having to replace either the rim or the tire.

In a subsidiary aspect, said attachment means attaches to the rim substantially without any part projecting into the inside of the tire beyond said rim. It allows for straightforward assembly of the tires onto the rim as there is no obstacle due to a protruding bolt for example.

In a further subsidiary aspect, said attachment means is a screw for traversing an aperture in a rim and for attaching to a corresponding recess in a sensor's housing; the screw head being shaped and configured to be retained by said rim within said aperture. This provides a particularly practical structure in terms of assembly and disassembly whilst achieving the advantages listed above.

In a further subsidiary aspect, said screw incorporates a channel through the screw which forms a conduit for linking the medium inside the tire to sensing means located in said housing. This allows the screw to have a dual function of attaching the sensing means as well as being a channel. It therefore uses minimal components for advantageous straightforward assembly and disassembly.

In a further subsidiary aspect, the wheel sensor housing is cylindrical with an end face for engaging the wheel rim; and incorporates a truncated edge portion so that when the housing is attached to the rim in close proximity to a bend in the rim profile, the housing is prevented from rotating in use as said edge portion abuts against the rim.

In a further subsidiary aspect, the invention provides an outer and inner tire combined wheel comprising a wheel sensor according to any of the preceding aspects located within the rim so as to establish a link between the medium inside the outer tire and sensing means. This will allow the outer tire conditions to be precisely assessed during, for example, a race.

In a further subsidiary aspect, a second wheel sensor is employed and configured to assess the medium of said inner tire. The combination of these two sensors will allow the overall wheel condition to be assessed, allowing an accurate picture of the level and conditions of usage of a tire which will improve the overall safety assessment of the tire during use.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 shows a first perspective view of a sensor mounted on a rim.

FIG. 2 shows a second perspective view of a sensor mounted on a rim.

FIG. 3 shows a part cross-sectional view of a sensor mounted to the outside of the tire within the rim.

FIG. 4 shows the inside of the upper outer housing half of the sensor in a perspective view.

FIG. 5 shows a further cross-sectional view of a sensor.

FIG. 6 shows a perspective view of a lower outer housing half.

FIG. 7 shows a part cross-sectional view of the countersunk screw as mounted between a housing and a rim.

FIG. 8 shows a side view of a lower outer housing half.

### DETAILED DESCRIPTION OF THE PREFERRED EMBODIMENTS

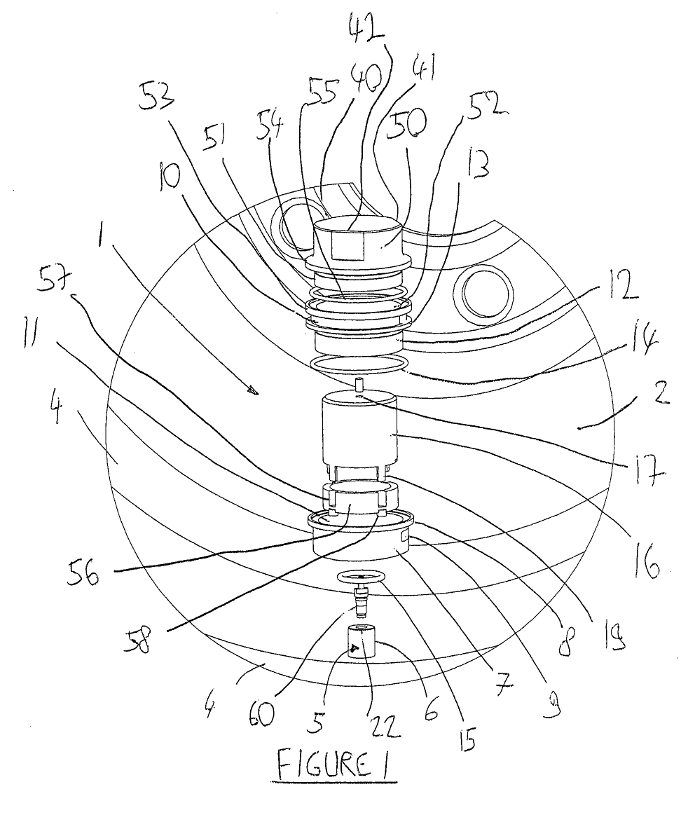

FIG. 1 shows a wheel sensor 1 in combination with a wheel rim 2. The wheel rim depicted in the figure is a so-called NASCAR wheel rim which is designed to accommodate two tires. The combination of tires on a rim incorporates an inner and an outer tire. The outer tire engages the rim along peripheral lines 3 and 4 about the rim.

The wheel sensor 1 is designed to be mounted on the outer side of the rim outside of the tire within the periphery of the rim. An aperture is cut out in the rim to allow the fitting of a countersunk mounting screw 5. Screw 5 has an external thread 6 about its outer periphery. Matching inner threads will be provided within outer housing lower portion 7 which may be made out of aluminum, an alloy or any other suitable material. Housing portion 7 incorporates a flange 8 extending radially outwards at the housing portion's upper most region. Two diametrically oppositely located indentations such as D-shaped indentation 9 are provided in the housing portion to allow the component to be better gripped by an operator or tooling for fixing the countersunk mounting screw onto the outer housing portion 7. These indentations may also allow the rim engaging lower housing portion to be secured whilst an outer spacer 10 is threaded onto the lower portion 7. Lower portion 7 incorporates an inner thread 11 for releaseable engagement with outer thread 12 located below flange 13 of the outer spacer 10 of the outer housing. Flange 13 may incorporate an annular trough in its underside in order to snugly fit over flange 8. Alternatively as shown in FIG. 1, an annular trough may be located within flange 8 in order to receive o-ring 14 which creates a seal between the spacer and the lower portion of the outer housing. Similarly, in order to create a seal between the pressurised outer tire and the atmosphere, an o-ring 15 is provided to be squashed between lower portion 7 and wheel rim 2.

Spacer 10 is attached to an upper outer housing portion 50. The upper housing portion 50 incorporates at its lower region a threaded portion 51 which mates with a corresponding threaded portion 52 located on an inner upper portion of the spacer. The junction between the upper outer housing portion 50 and the spacer 10 occurs at two corresponding flanges 53 and 54 which grasp a further o-ring 55 as shown in FIG. 1.

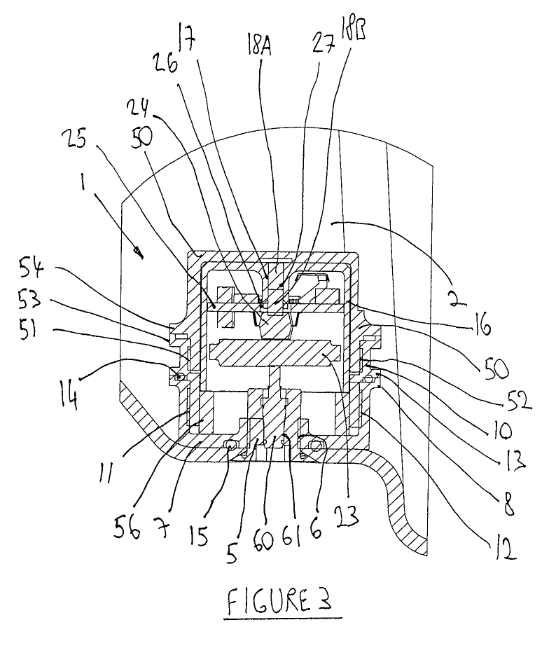

The electronic sensing means is housed in a further housing generally referenced 16. Housing 16 has in its upper surface a cylindrical recess 17 for receiving at least one filter. The embodiment of FIG. 1 shows two filters (in FIG. 3) 18A and 18B located in series on the central axis of the sensor. Housing 16 may be made of nylon and incorporate at its lower extremity four lugs such as lug 19 designed to fit into mating recesses 57 provided in an internal spacer 56 located between the bottom face of housing portion 7 and housing 16. The housing incorporates two sideways holes 70 and 71 which allow insertion of polyurethane based potting material or the like in order to protect the electronics of the sensor. The battery itself would be potted.

The internal spacer 56 also incorporates a number of lugs 58 which mate with corresponding recessed portions located in lower portion 7. In one embodiment, it is envisaged that housing portion 7 may be of aluminum. The lugs and recesses may be arranged so that they fit in only one position. The provision of recesses and lugs may be reversed if appropriate. In other words, the housing portion 7 may incorporate lugs which fit into recesses provided in the spacer. As an alternative to the lugs and recesses of this kind, the upper surface of the sensor housing may also incorporate two smaller recesses of cylindrical shape designed to receive location pins which would fit into further recesses provided in this alternative embodiment in the inner upper face of housing portion 50. These arrangements serve to prevent rotation of the electronic sensor housing within the outer housing. The upper most portion of upper outer portion 50 incorporates a number of facets such as facets 40, 41 and 42 which truncate an otherwise substantially cylindrical portion of portion 50. In an alternative, embodiment the contour may be a pentagonal contour. For either of these embodiments, a correspondingly shaped tool may be provided in order to allow the tightening or loosening of the outer portions.

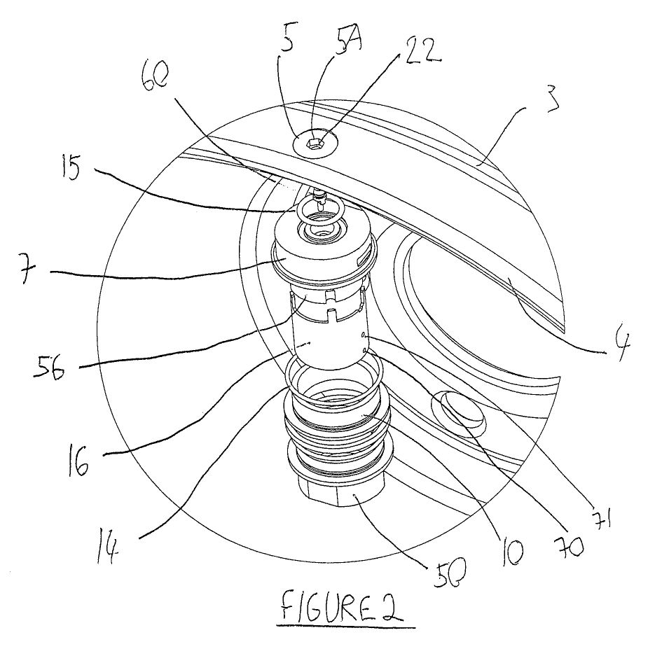

FIG. 2 shows the wheel sensor of FIG. 1 from the opposite direction of that shown in FIG. 1. Identical components have retained identical numerical references for clarity. The head of the countersunk mounting screw 5 can be seen. It incorporates a faceted hexagonal recess 5A for co-operation with a tool for tightening the screw and the housing together. Within the hexagonal recess, the upper part of a channel 22 can be seen allowing the air from the outer tire to pass the screw in order to reach the electronic sensing means.

A valve 60 is located in channel 22 and is secured to screw 5 via releasable attachment means or permanent attachment means. A screw thread 61 engages a corresponding internal screw thread located in channel 22. The valve may be of the Schrader kind either with a long or short core. The valve incorporates a core which forms a seal with the screw. When the sensor is not fitted, there is no force on the valve core so the spring of the valve stays uncompressed and the tire stays inflated. When the sensor is fitted onto the countersunk screw, the top surface of the sensor hits the valve core and breaks the seal. This allows air into the sensor housing so that pressure may be monitored. When the sensor needs to be removed, the housing is unscrewed and the sensor drops away from the valve core. This allows the valve core to be extended and seals the tire.

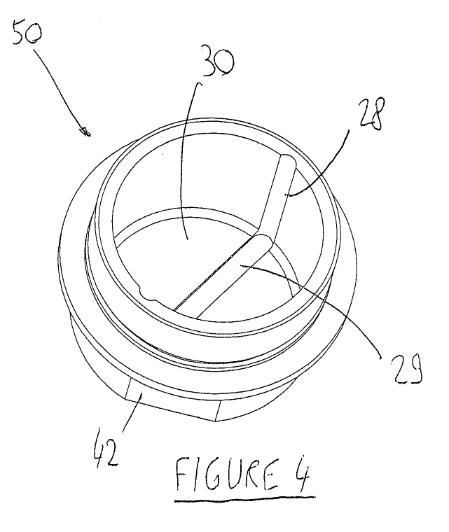

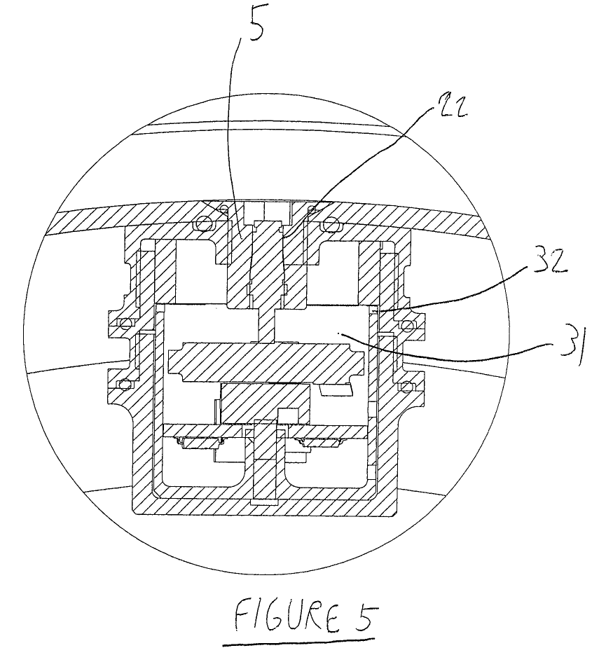

In FIG. 3, identical reference numerals are employed as in the previous figures for identical components. The inside of electronics housing 16 comprises the necessary elements to perform pressure sensing. There is provided a button lithium battery 23 for powering the sensor. A pressure sensing chip 24 is mounted on a circuit board 25. The circuit board comprises an aperture 26 located at a central position of the housing of sufficient diameter to allow air to pass through in order to detect its pressure. The circuit board is tightly attached to housing 16 so that aperture 26 is in line with passage 27 which extends between aperture 26 and filters 18A and 18B in housing 16. An arrangement of tunnels is provided in the inner surface of the upper outer housing portion 50 as shown in greater detail in FIGS. 4 and 5.

FIG. 4 shows upper outer housing portion 50 showing a number of tunnels 28 and 29. Tunnel 28 extends along the inner surface of half 10 in the longitudinal direction whilst tunnel 29 extends diametrically across the inner surface of end face 30.

The air from the inner side of an outer tire passes, as shown in FIG. 5, through counter sunk screw 5 through the open valve of tunnel 22 into chamber 31. An aperture 32 is provided between chamber 31 and tunnel 28. The air is then allowed to pass through tunnel 28 and tunnel 29 to filters 18A and 18B.

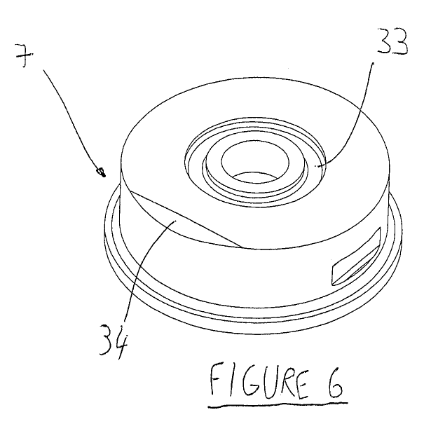

FIG. 6 shows lower outer housing portion 7 in greater detail. Identical numerical references have been employed for identical components as previously described. This outer housing portion incorporates an annular trough 33 suitable for receiving an o-ring. A truncated edge portion 34, which will allow, when the housing is attached to the rim in close proximity to the bend in the rim profile, as shown for example in FIG. 3, the housing will be prevented from rotating in use as said edge portion will abut against the rim.

When the sensor is used in an outer and inner tire combined wheel, such as the two-tire set-up in a NASCAR, it is ideally suited to measure the pressure in the outer tire. The electronics may be such as to transmit pressure values to an electronic control unit of known kind or to any other receiving means for further processing. A wireless transmitter is therefore envisaged within the wheel sensor unit described above. It is also envisaged to use this kind of sensing in combination with other kinds of sensors such as a sensor located inside the inner tire if necessary. This would allow the assessment of pressure in the inner and outer tire to be achieved.

The sensor also incorporates a temperature sensor.

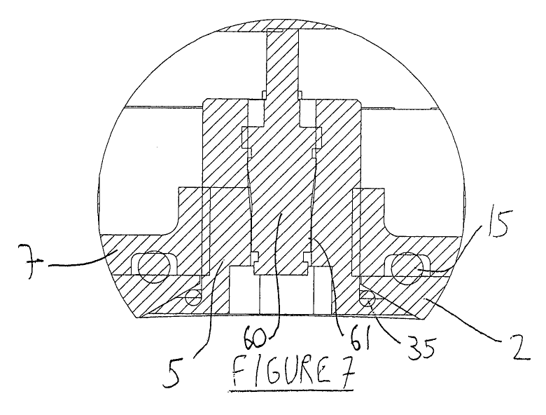

FIG. 7 uses identical numerical references for the components described previously. An O-ring 35 is employed between the countersunk screw head and rim 2 to create a seal in order to prevent leaking between the two beads.

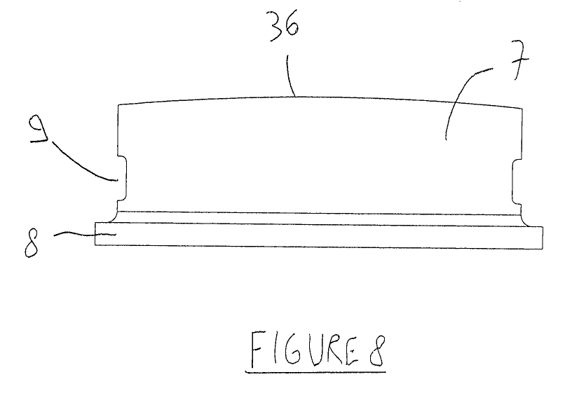

FIG. 8 uses identical numerical references for the components described previously. The top surface 36 of the housing 7 is bowed in order to fit to the rim and stop the housing from rotating. This housing may be made out of aluminum or any other suitable material such as titanium. Any other suitable alloy or material may be used.

The scope of the invention is defined in the claims which now follow.

What is claimed is:

1. A wheel sensor which is primarily located outside of a pneumatic tire comprising sensing means for sensing at least one condition within the pneumatic tire of a wheel and an attachment means for securing said sensing means to the wheel rim;
wherein said attachment means establishes a link between the medium inside the tire and said sensing means; and
comprises a valve which seals when the sensing means is removed and opens when the sensing means is attached to the rim.

2. A wheel sensor according to claim 1, wherein said attachment means attaches to the rim substantially without any part projecting into the inside of the tire beyond said rim.

3. A wheel sensor according to claim 1, wherein said attachment means is a screw for traversing an aperture in a rim and for attaching to a corresponding recess in a sensor's housing; the screw head being shaped and configured to be retained by said rim within said aperture.

4. A wheel sensor according to claim 3, wherein said screw incorporates a channel through the screw which forms a conduit for linking the medium inside the tire to sensing means located in said housing.

5. A wheel sensor according to claim 1, wherein the wheel sensor housing is cylindrical with an end face for engaging the wheel rim; and incorporates a truncated edge portion; whereby when the housing is attached to the rim in close proximity to a bend in the rim profile, the housing is prevented from rotating in use as said edge portion abuts against the rim.

6. An outer and inner tire combined wheel, comprising a wheel sensor according to claim 1 located within the rim for establishing a link between the medium inside the outer tire and sensing means.

7. An outer and inner tire combined wheel according to claim 6, comprising a second wheel sensor configured to assess the medium of said inner tire.
